(19) United States
(12) Patent Application Publication
(10) Pub. No.: US 2010/0177751 A1
(43) Pub. Date: Jul. 15, 2010

(54) SYSTEM AND METHOD OF DELIVERING CONTENT OVER A LOCAL WIRELESS SYSTEM

(75) Inventors: Larry G. Fischer, Waseca, MN (US); Jamie Brown, Prior Lake, MN (US); Mahesh Patel, Streamwood, IL (US); Tony Lefebvre, Edina, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/351,059

(22) Filed: Jan. 9, 2009

(51) Int. Cl. H04W 4/02; H04W 24/00

(52) U.S. Cl. 370/338; 455/456.3

(57) ABSTRACT

A local wireless system comprises a plurality of wireless communication units to transmit to and receive wireless signals from one or more wireless devices and a soft switch coupled to the plurality of wireless communication units to obtain connection information for each of the one or more wireless devices. The soft switch comprises a memory to store the connection information and location-based data associated with a service area of the plurality of wireless communication units; and a gateway to process non-real-time data requests and provide an interface to a packet network. The soft switch is operable to push the location-based data from the memory to at least a subset of the one or more wireless devices using the connection information stored in the memory.

### CROSS-REFERENCE TO RELATED APPLICATIONS

This application is related to the following co-pending United States patent applications filed on even date herewith, all of which are hereby incorporated herein by reference:

U.S. patent application Ser. No. ______ (attorney docket number 100.864US01 entitled “SYSTEM AND METHOD OF DELIVERING CONTENT USING NETWORKED WIRELESS COMMUNICATION UNITS”) and which is referred to herein as the '864 Application;

U.S. patent application Ser. No. ______ (attorney docket number 100.917US01 entitled “SYSTEM AND METHOD OF DELIVERING CONTENT FROM A WIRELESS COMMUNICATION UNIT”) and which is referred to herein as the '917 Application;

### BACKGROUND

Wireless communication has become increasingly popular and accessible. In particular, wireless technology is currently available which enables a user to access and receive non-real-time data over a wireless network using a wireless device such as a cell phone or a laptop computer. For example, users can access the internet, email, etc. using a wireless device. Non-real-time data, such as web pages, music, etc. is typically stored on content servers and accessed via a data network such as the internet Additionally, many services use wireless technology to provide users with location-based data. Various techniques have been developed to determine a user's location and provide content, such as advertisements, based on the user's location.

However, the ability to access non-real-time data and provide location-based data is placing increasing burdens on the available bandwidth of conventional wireless networks such as Global System for Mobile communications (GSM) networks. The increased bandwidth burden may lead to more dropped calls and poorer service quality similar to the problems experienced by landline telephone service providers shortly after the advent of internet access via phone lines. One possible solution to the problem of bandwidth burden is to limit or cut off access to non-real-time data for users with high-volumes of non-real-time data traffic. This solution, however, may cause a decline in subscribers and does not answer the growing demand for access to non-real-time data over wireless networks.

For the reasons stated above and for reasons that shall become apparent to one of ordinary skill in the art upon reading and studying the present application, there is a need in the art for a system which relieves the burden placed on wireless networks by access to stored non-real-time data.

### SUMMARY

In one embodiment, a local wireless system is provided. The local wireless system comprises a plurality of wireless communication units to transmit to and receive wireless signals from one or more wireless devices and a soft switch coupled to the plurality of wireless communication units to obtain connection information for each of the one or more wireless devices. The soft switch comprises a memory to store the connection information and location-based data associated with a service area of the plurality of wireless communication units; and a gateway to process non-real-time data requests and provide an interface to a packet network. The soft switch is operable to push the location-based data from the memory to at least a subset of the one or more wireless devices using the connection information stored in the memory.

### DRAWINGS

FIG. 1 is a block diagram showing one embodiment of a wireless network.

FIG. 2 is a block diagram showing an exemplary configuration of an area of interest.

FIG. 3 is a flow chart depicting one embodiment of a method of delivering location-based data to a wireless device.

FIG. 4 is a flow chart depicting another embodiment of a method of delivering non-real-time data to a wireless device.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures or the specification is not to be construed as limiting the order in which the individual steps may be performed. The following detailed description is, therefore, not to be taken in a limiting sense.

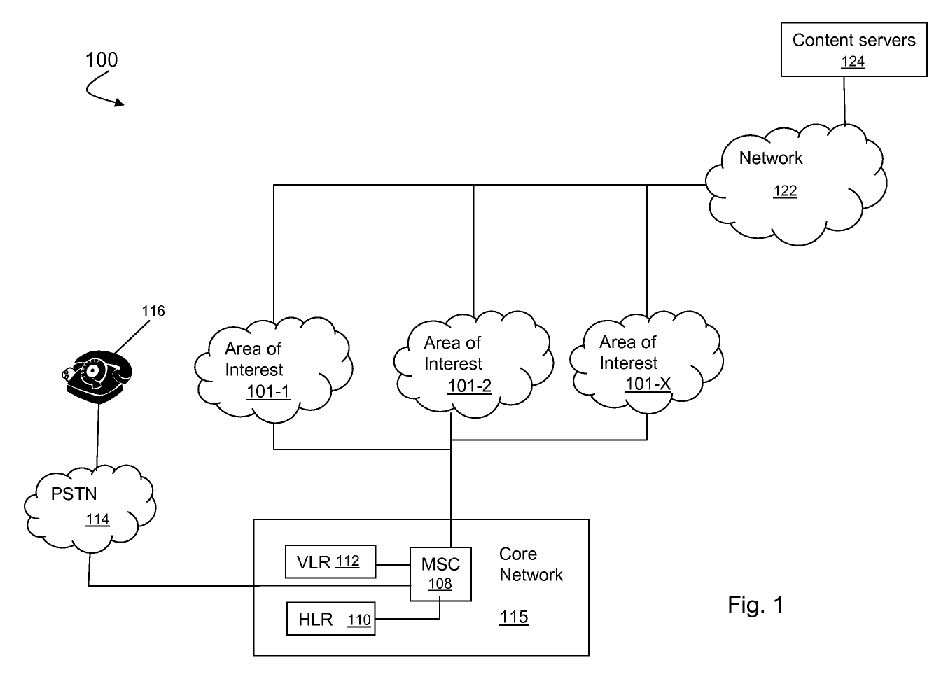

FIG. 1 is a block diagram of one embodiment of a wireless network 100. Network 100 reduces the bandwidth burden for delivery of non-real-time content to wireless devices compared to a conventional wireless networks. Exemplary wireless devices include mobile phones, personal digital assistants (PDA), laptops, and any other device configured to connect to wireless network 100. In particular, network 100 includes a plurality of areas of interest 101-1 . . . 101-X. An area of interest 101 is a geographical sub-division within network 100 in which a plurality of mobile devices are located. Exemplary areas of interest include, but are not limited to, shopping centers, college campuses, cities, etc.

Each area of interest 101-1 . . . 101-X includes a packet gateway to couple each area of interest directly to a packet switched network 122, such as the internet. Each area of interest is also coupled to a circuit switched network 114, such as the public switched telephone network (PSTN), via a central core network 115. As used herein, a core network includes centralized components that provide authentication services, routing of real-time data (e.g. voice calls) and/or an interface to a circuit-switched network such as the Public Switched Telephone Network (PSTN) 114. In this exemplary embodiment, network 100 is a Global System for Mobile communications (GSM) network and core network 115 comprises a mobile switching center (MSC) 108, visitor location register (VLR) 112, and home location register (HLR) 110.

Although the exemplary embodiments are described herein with respect to a Global System for Mobile communications (GSM) network, it is to be understood that other embodiments can be implemented using other network technologies. For example, other embodiments implement Universal Mobile Telecommunications System (UMTS), Worldwide Interoperability for Microwave Access (WiMAX), Code Division Multiple Access 2000 (CDMA2000), Ultra Mobile Broadband (UMB), and Long Term Evolution (LTE).

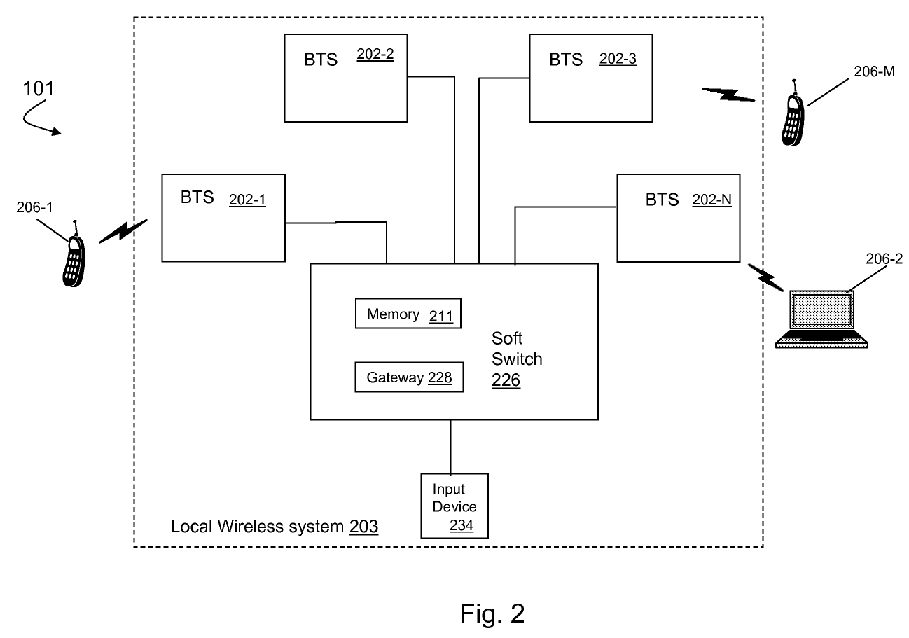

An exemplary configuration of an area of interest 101 is shown in FIG. 2. Area of interest 101 implements a local wireless system 203. A local wireless system, as used herein, is a sub-system of a wireless network which is configured to manage, independently of the core network 115, communication between wireless devices located in the respective area of interest. For example, after wireless devices 206-1 and 206-M authenticate to network 100 via core network 115, the local wireless system 203 is able to route and otherwise manage communication between wireless devices 206-1 and 206-M without the need to communicate with MSC 108.

In this embodiment, wireless communication units 202-1 . . . 202-N in local wireless system 203 are implemented as Global System for Mobile communication (GSM) base transceiver stations. As mentioned above, although wireless communication units 202-1 . . . 202-N are shown and described in relation to a GSM network, it is to be understood that modifications to network 100 can be made in order to use other cellular technologies. For example, wireless communication units 202-1 . . . 202-N can be implemented as Radio Network Controllers (RNC) in a UMTS network or as Access Service Network (ASN) Base Stations (BS) in a WiMAX network.

Local wireless system 203 comprises a plurality of wireless communication units 202-1 . . . 202-N coupled to a soft switch 226. Soft switch 226 routes real-time data, such as voice calls, between wireless devices 206-1 . . . 206-M located within area of interest 101. In the example described here, soft switch 226 implements functionality of a GSM core network. In particular, soft switch 226 implements functionality of a GSM base station controller, switching center, and location register. However, it is to be understood that in other embodiments implementing other telecommunication technologies, soft switch 226 implements functionality corresponding to the technology used to route real-time data.

In addition, soft switch 226 includes a memory 211 and a gateway 228. Memory 211 is configured to store location-based data. Location-based data, as used herein, is data associated with the area in which the wireless communication units are located. For example, location-based data includes, but is not limited to, advertisements and/or coupons for goods and services sold in the area; local news or notices, such as campus headlines or notice that a particular class is canceled; emergency alerts, such as Amber alerts or other safety notices; etc. In addition, the term “push” is defined as initiating the provision of content without waiting for a data request from a wireless device.

Soft switch 226 controls pushing location-based data stored in memory 211 to one or more of wireless devices 206-1 . . . 206-M. In particular, soft switch 226 obtains connection information for each wireless device 206-1 . . . 206-M which connects to network 100 via one of wireless communication unit 202-1 . . . 202-N. Connection information includes, but is not limited to, the assigned transmit frequency for transmitting to the wireless device and an identification number such as the Mobile Subscriber Integrated Services Digital Network (MSISDN) number. In one embodiment, soft switch 226 obtains the connection information by monitoring communication between each wireless device 206-1 . . . 206-M and core network 115 during the authentication or handoff procedures.

Soft switch 226 stores the obtained connection information in memory 209. In addition, as stated above, soft switch 226 controls operation of wireless communication unit 206-1 . . . 206-M similar to a conventional base station controller. Soft switch 226 uses the connection information stored in memory 211 to route communication, such as text messages and voice calls, between wireless devices 206-1 . . . 206-M. When one of wireless devices 206-1 . . . 206-M attempts to communicate with a device, such as landline telephone 116, soft switch 226 routes the call to MSC 108 in core network 115 for further routing. In such circumstances, soft switch 226 appears as a base station controller to MSC 108. This enables embedding local wireless system 203 in network 100 without requiring changes to other network components such as MSC 108.

In operation, when soft switch 226 detects a wireless device (wireless device 206-1 in this example) authenticate to the network or has been handed off to one of wireless communication units 202-1 . . . 202-N inside local wireless system 203, soft switch 226 determines if location-based data is to be delivered to the wireless device 206-1. In some embodiments, soft switch 226 pushes location-based data to wireless devices 206-1 . . . 206-M whenever the wireless devices are authenticated or handed off. In other embodiments, soft switch 226 determines if wireless devices 206-1 . . . 206-M are registered to receive location-based data by checking a list of registered wireless devices. A user can register a wireless device to receive location-based data by previously sending a text message to a specific number, for example. If wireless device 206-1 is registered, soft switch 226 directs the wireless communication unit in communication with wireless device 206-1 (wireless communication unit 202-2 in this example) to push the location-based data stored in memory 211 to the registered wireless device 206-1. If wireless device 206-1 is not registered, soft switch 226 does not direct the wireless communication unit 202-2 to push the location-based data.

Alternatively, soft switch 226 is instructed, in some embodiments, to push location-based data to at least a subset of wireless devices 206-1 . . . 206-M based on an input from input device 234 rather than based on the authentication of wireless devices 206-1 . . . 206-M to network 100. For example, if a child is abducted, an input from input device 234 instructs soft switch 226 to cause each of wireless communication units 202-1 . . . 202-N to push an Amber alert to each of wireless devices 206-1 . . . 206-M or to a subset of wireless devices 206-1 . . . 206-M which are registered to receive Amber alerts.

In addition, input device 234 is used in some embodiments to provide the location-based data to be stored on memory 211. For example, in one embodiment, the details of an Amber alert are pushed to wireless devices 206-1 . . . 206-M and stored on memory 211 for use later in pushing the Amber alert to additional wireless devices which enter the local wireless system 203 service area at a later time. Other location-based data, such as coupons, local news, etc. can also be provided by input device 234 to be stored on memory 211.

Additionally, in some embodiments, memory 211 caches non-real-time data. As used herein, real-time data is defined as data which is transmitted at substantially the same time as it is created, such as voice data and text messages. Hence, as used herein, non-real-time data, such as web pages, music, etc., is defined as data which is not transmitted at substantially the same time as it is created. In other words, non-real-time data is data which is stored for later access or transmission.

Gateway 228 in soft switch 226 analyzes requests for non-real-time data received from wireless devices 106-1 . . . 106-M to determine if the requested data is stored in memory 211. If the non-real-time data is stored in memory 211, soft switch 226 retrieves the data from memory 211 and provides the data to the wireless device 206 which requested the data.

The non-real-time data to be stored in memory 211 is selected, in some embodiments, based on actual requests received from wireless devices 206-1 . . . 206-M. For example, in one embodiment, memory 211 is updated by deleting the last accessed data with more recently accessed data. In this way, data that is requested more often is kept in cache to improve performance. In other embodiments, the data to be stored is also determined by anticipating requests. In other words, if a history of requests indicates that a particular file or data is typically requested frequently, memory 211 can store that data prior to any actual requests in anticipation of the frequent requests. For example, if a history of requests indicates that a given news site is accessed by many users each morning, memory 211 caches the given news site each morning prior to receiving any requests in anticipation of requests for the news site.

If a wireless communication unit receives a request for non-real-time data not stored in memory 211, gateway 228 provides an interface to packet network 122 to pass the request over network 122 and retrieve the requested data from content servers 124. However, by caching non-real-time data in memory 211, the bandwidth burden placed on core network 115 is reduced. By providing an interface directly to network 122, bandwidth burden placed on core network 115 is further reduced.

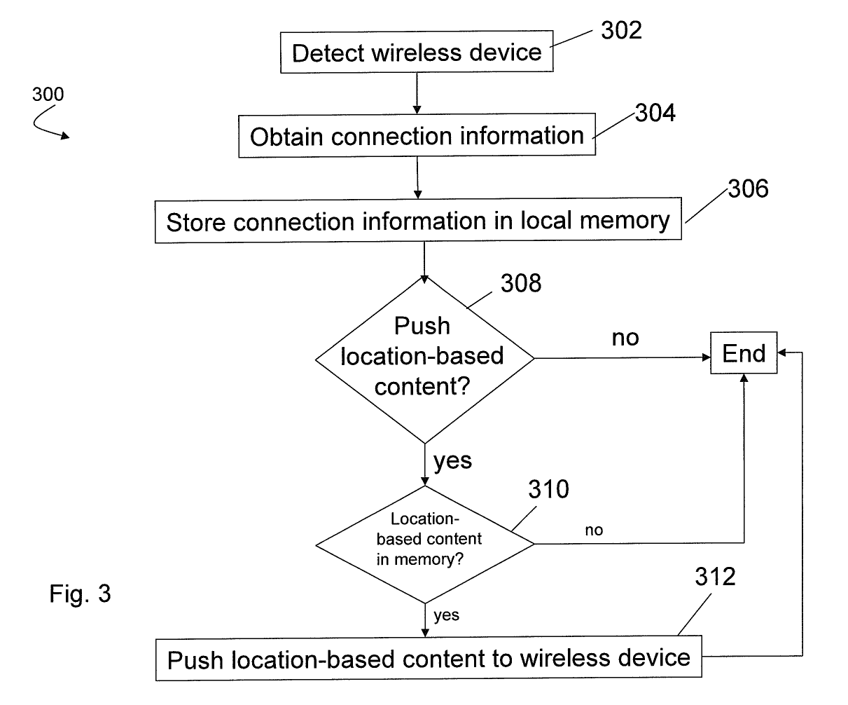

FIG. 3 is a flow chart of one embodiment of a method 300 of delivering location-based data to a wireless device. Method 300 is implemented in an area of interest having a local wireless system such as local wireless system 203 in network 100 above. At block 302, a wireless device (e.g. wireless device 206) is detected in a service area of one of a plurality of wireless communication units (202) in the local wireless system. For example, a wireless device can be detected during handoff procedures or when a wireless device powers on and connects to the network.

At block 304, connection information for the detected wireless device is obtained. In particular, a soft switch (e.g. soft switch 226) monitors communication between the detected wireless device and a remote core network (e.g. core network 115) during authentication procedures. By monitoring the communication, the soft switch obtains the identifying information such as the Electronic Serial Number (ESN) and Mobile Identification Number (MIN). The soft switch also obtains the assigned transmit frequency for the detected wireless device. At block 306, the obtained connection information is stored in a memory (e.g. memory 211) of the soft switch.

At block 308, the soft switch determines if location-based data is to be pushed to the detected wireless device. For example, in some embodiments, location-based data is only pushed if the wireless device is registered to receive pushed location-based data. In other embodiments, location-based data is pushed whenever a new wireless device is detected. In yet other embodiments, location-based data is pushed upon receiving a command from an input device.

If the soft switch determines that location-based data is to be pushed to the detected wireless device, the soft switch then determines if the location-based data is stored in the memory of the soft switch at 310. If the location-based data is stored in the memory, the soft switch pushes the location-based data to the wireless device, at 312, using the connection information provided to the wireless communication unit by the local switching center.

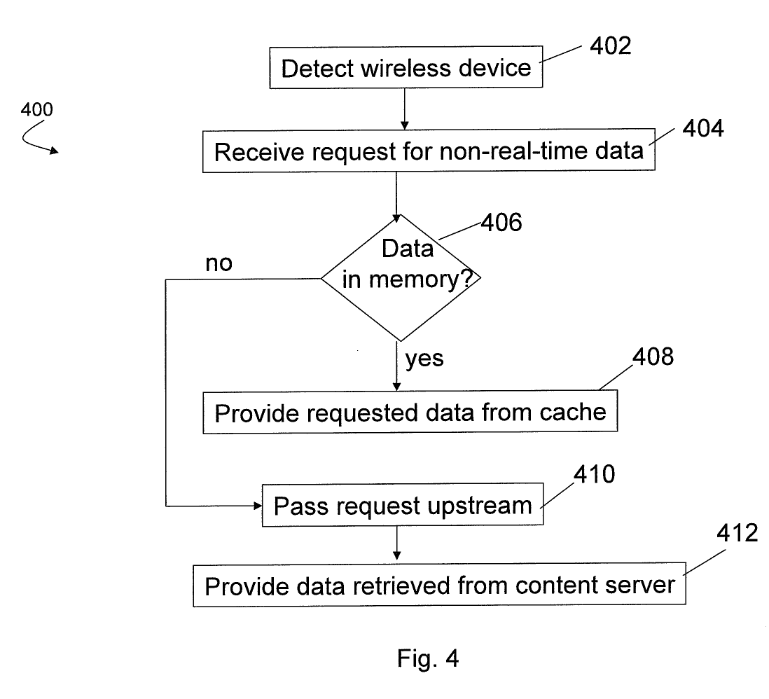

FIG. 4 is a flow chart depicting a method 400 of delivering requested non-real-time data to a wireless device. Method 400 can be used in combination with method 300 above in an area of interest having a local wireless system such as local wireless system 203 in network 100 above. At block 402, a wireless device (e.g. wireless device 206) is detected in a service area of one of a plurality of wireless communication units (202) in the local wireless system. For example, a wireless device can be detected during handoff procedures or when a wireless device powers on and connects to the network.

At block 404, a request for non-real-time data is received from the detected wireless device over the assigned receive frequency for the detected wireless device. At block 406, a soft switch in the local wireless system determines if the requested non-real-time data is stored in its memory (e.g. memory 211). If the requested non-real-time data is stored in its memory, the soft switch provides the non-real-time data to the corresponding wireless communication unit for transmission over the corresponding transmit frequency assigned to the wireless device at block 408. If the requested non-real-time data is not stored in the memory of the soft switch, the soft switch passes the request upstream, at block 410, to retrieve the requested non-real-time data from a content server (e.g. content server 124) over a packet network as known to one of skill in the art. In particular, a gateway in the soft switch provides an interface to the packet network such that the burden on the core network is reduced for delivery of non-real-time data. The requested data retrieved from the content server is then provided to the wireless device at block 412.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1 A local wireless system comprising:
a plurality of wireless communication units to transmit to and receive wireless signals from one or more wireless devices; and
a soft switch coupled to the plurality of wireless communication units to obtain connection information for each of the one or more wireless devices, wherein the soft switch comprises:
a memory to store the connection information and location-based data associated with a service area of the plurality of wireless communication units; and
a gateway to process non-real-time data requests and provide an interface to a packet network;
wherein the soft switch is operable to push the location-based data from the memory to at least a subset of the one or more wireless devices using the connection information stored in the memory.

2. The local wireless system of claim 1, wherein the soft switch is further operable to route real-time data between a first wireless device located in a service area of the local wireless system and a second wireless device located in the service area of the local wireless system.

3. The local wireless system of claim 2, wherein the soft switch is further operable to route real-time data to a core network if a first wireless device is communicating with a device not located in the service area of the local wireless system.

4. The local wireless system of claim 1, wherein each of the plurality of wireless communication units is one of a Global System for Mobile communications (GSM) base transceiver station, a Universal Mobile Telecommunications System (UMTS) Radio Network Controller (RNC), and a Worldwide Interoperability for Microwave Access (WiMAX) Access Service Network (ASN) Base Station (BS).

5. The local wireless system of claim 1, further comprising an input device coupled to the soft switch and operable to provide location-based data to the soft switch.

6. The local wireless system of claim 1, wherein the soft switch is operable to check a list of registered wireless devices and to push location-based data only to the registered wireless devices.

7. The local wireless system of claim 1, wherein the location-based data comprises one or more of advertisements, coupons, news, and emergency alerts.

8. A wireless network comprising:
a plurality of areas of interest, each area of interest comprising:
a plurality of wireless communication units to transmit to and receive wireless signals from one or more wireless devices; and
a soft switch coupled to the plurality of wireless communication units to obtain connection information for each of the one or more wireless devices, wherein the soft switch comprises:
a memory to store the connection information and location-based data associated with a service area of the plurality of wireless communication units; and
a gateway to process non-real-time data requests and provide an interface to a packet network;
wherein the soft switch is operable to push the location-based data from the memory to at least a subset of the one or more wireless devices using the connection information stored in the memory; and
a central core network coupled to the soft switch in each of the plurality of areas of interest, wherein each soft switch is operable to route real-time data to the central core network if one of the one or more wireless devices is communicating with a device not located in the respective area of interest;
wherein each soft switch is further operable to push the location-based data from the respective memory to at least a subset of the one or more wireless devices using the connection information stored in the memory.

9. The wireless network of claim 8, wherein each soft switch is further operable to cache non-real-time data in its respective memory to provide the cached non-real-time data to at least one of the one or more wireless device from its respective cache in response to a request from the at least one wireless device.

10. The wireless network of claim 8, wherein each soft switch is further operable to route real-time data between a first wireless device in the respective area of interest and a second wireless device in the same area of interest.

11. The wireless network of claim 8, wherein each of the plurality of wireless communication units is one of a Global System for Mobile communications (GSM) base transceiver station, a Universal Mobile Telecommunications System (UMTS) Radio Network Controller (RNC), and a Worldwide Interoperability for Microwave Access (WiMAX) Access Service Network (ASN) Base Station (BS).

12. The wireless network of claim 8, further comprising an input device in each of the plurality of areas of interest coupled to the respective soft switch to provide location-based data to the soft switch.

13. The wireless network of claim 8, wherein each soft switch is operable to check a list of registered wireless devices and to push location-based data only to registered wireless devices.

14. The wireless network of claim 8, wherein the location-based data comprises one or more of advertisements, coupons, news, and emergency alerts.

15. A method of delivering location-based data to a wireless device, the method comprising:
detecting the wireless device in an area of interest comprising a plurality of wireless communication units;
obtaining connection information for the wireless device;
storing the connection information in a memory associated with a soft switch in area of interest;
determining if location-based data is to be pushed to the detected wireless device; and
pushing the location-based data to the wireless device from the memory associated with the soft switch.

16. The method of claim 15, wherein pushing the location-based data to the wireless device from memory associated with the soft switch comprises:
providing the location-based data from the memory to at least one of the plurality of wireless communication units; and
transmitting the location-based data to the wireless device from the at least one wireless communication unit.

17. The method of claim 15 wherein obtaining connection information comprises monitoring communication between the detected wireless device and a central core network coupled to the soft switch.

18. The method of claim 15, wherein determining if location-based data is to be pushed comprises checking a list of wireless devices registered to receive pushed location-based data.

19. The method of claim 15, wherein determining if location-based data is to be pushed comprises receiving an instruction from an input device indicating that the location-based data is to be pushed.

20. The method of claim 15, wherein pushing location-based data comprises pushing one or more of advertisements, coupons, news, and emergency alerts.
